(19) United States
(12) Patent Application Publication
(10) Pub. No.: US 2009/0317436 A1
(43) Pub. Date: Dec. 24, 2009

(54) COMPUTER DEVICES AND ACCESSORIES

(76) Inventors: Mike Wilson, London (GB); Ivan P. Parkin, London (GB); Sean Nair, London (GB); Jesus J. Gil-Tomas, Valencia (ES)

Correspondence Address: NIXON & VANDERHYE, PC, 901 NORTH GLEBE ROAD, 11TH FLOOR, ARLINGTON, VA, 22203, US

(21) Appl. No.: 12/376,163

(22) PCT Filed: Aug. 2, 2007
(86) PCT No.: PCT/GB07/02946

§ 371 Date: Mar. 11, 2009

(30) Foreign Application Priority Data
Aug. 4, 2006 (GB) 0615551.9
Dec. 1, 2006 (GB) 0624088.1
Jun. 22, 2007 (GB) 0712307.8

(51) Int. Cl. A01N 25/34; G06F 3/02; G06F 3/033; B05D 3/02; C08K 5/56; A01P 1/00; B23P 11/00

(52) U.S. Cl. 424/411; 345/168; 345/163; 427/372.2; 524/176; 29/428; 977/773; 250/492.1

(57) ABSTRACT

Computer devices (10) that are resistant to contamination by microbes are provided. The device (such as a keyboard (10), mouse or other computer device) is treated or manufactured with a photosensitizer compound that is activated by electromagnetic radiation (16) to provide an antimicrobial effect. One or more light sources (14; 19) may be utilized to activate the photosensitizer compound and these may be incorporated inside or outside of the computer device (10). A laptop computer in which the electro-magnetic radiation is provided by the display screen (30) so as to provide an antimicrobial effect to the keyboard (13) is described.

The present invention relates to computer devices and accessories such as covers. More particularly, the invention relates to computer devices, preferably input devices, that are treated, modified, covered or manufactured so as to be resistant to contamination by microbes.

### BACKGROUND

Contamination of computer input devices, such as keyboards, by microbes in hospitals has recently received considerable attention as it is thought that such input devices may be major reservoirs of microbes (e.g. methicillin-resistant Staphylococcus aureus—MRSA) responsible for hospital-acquired infections. Numerous studies have shown that MRSA and other pathogens can be found on keyboards in hospitals.

One obvious response to this problem would be to apply liquid disinfectants to the keyboard to kill the microbes present. This, however, has several disadvantages. The disinfection process can be time-consuming and ineffective, especially on surfaces such as computer keyboards which have many nooks and crannies that are difficult to access. Furthermore, liquid disinfectants are (1) susceptible of being mixed at the incorrect concentration, which reduces their effectiveness, (2) can be rapidly inactivated by the presence of organic material (which will almost certainly be present on keyboards) and (3) can deteriorate over time. In addition, liquid disinfectants can damage the device material, interfere with its proper functioning and thus shorten the life of the computer input device.

It would therefore be desirable to address the problem of the presence of microbes on computer input devices in a way which avoids one or more of the above shortcomings.

U.S. Pat. No. 6,420,455 discloses a method for incorporating polymers with photosensitizers. The use of such polymers in computer input devices is, however, not foreseen. The disclosure of U.S. Pat. No. 6,420,455, and in particular the methods disclosed for producing an antibacterial polymer, are incorporated herein by reference.

### SUMMARY OF THE INVENTION

The invention provides an alternative approach to computer device disinfection which does not require any action by the user. The invention can in one aspect be described as a self-disinfecting computer input device or accessory. This can be achieved by utilizing a photosensitizer that provides an antimicrobial effect when activated by electromagnetic radiation. The photosensitizer compound serves to kill microbes, such as MRSA, that may be present on, or come into contact with, the surface of the computer device.

The photosensitizer is an antimicrobial agent activated by electromagnetic radiation, preferably activated by light, more preferably visible light. The mechanism of antimicrobial activity is usually the generation of antimicrobial chemicals (e.g. singlet oxygen or free radicals) when illuminated. The antimicrobial agents retain their activity even when embedded in a polymer such as cellulose acetate. Thus, the invention includes the manufacture of the input device from a polymer having the photosensitizer embedded therein as well as the coating of an input device with such a polymer or with the neat photosensitizer.

The invention may be arranged such that the photosensitizer is activated by ambient light in which case the antimicrobial effect will be present whenever the input device is so illuminated. Alternatively or additionally, the photosensitizer may be arranged to be activated with specific wavelengths. Dedicated light sources may be provided, either internally or externally, to provide light to the photosensitizer. The light source may comprise a light emitting diode, laser, laser diode, tungsten filament lamp or fluorescent tube, for example.

The input device is preferably provided with a controller for determining whether the input device is being actively used. Such controller can be used to determine the frequency or time points at which the input device is bathed in electromagnetic radiation. For example, the controller can be arranged to initiate the supply of electromagnetic radiation after a certain time period of inactivity has elapsed. Additionally or alternatively, electromagnetic radiation can be supplied at times when the computer to which the input device is turned off and/or whenever the computer is turned on. Further, the controller can arrange for the supply of light to be initiated whenever the device is being actively used. When the input device is a computer keyboard, illumination can be arranged to occur whenever a key is depressed or after a fixed time period following the pressing of a key.

When the input device is a keyboard, the photosensitizer is preferably provided on at least the keys of the keyboard, but may be provided to the entire external surface or just the top surface. Light can be delivered from inside of the keyboard itself, for example via optical fibres that respectively lead to each of the keys or by utilizing a transparent polymer for the keyboard structure such that light is able to reach each of the keys from one or only a few light sources. Additionally or alternatively, the light source can be located externally to the keyboard, preferably above the keyboard so as to bathe the keyboard in illumination. The light source for this purpose may be physically connected to the keyboard or not.

The invention also comprises a method of making an antimicrobial computer input device in which a liquid photosensitizer is sprayed on to the device and allowed to dry. This provides an antimicrobial coating. Alternatively, the method can comprise embedding the photosensitizer into a polymer and manufacturing at least a part of the input device from the polymer. Such a part can be the key of a computer keyboard, the button of a mouse, etc.

The invention further includes a laptop computer comprising a keyboard, in which the keys of the keyboard are provided with a photosensitizer that provides an antimicrobial effect when activated by electromagnetic radiation. In a preferred embodiment, the display screen of the laptop computer can be used to provide the necessary electromagnetic radiation. A controller can be provided which causes the display screen to emit electromagnetic radiation at a predetermined wavelength, for example when the display screen is closed down over the keyboard. This allows the electromagnetic radiation to be provided in close proximity to the keyboard. The controller can arrange for such electromagnetic radiation to be provided for a predetermined period of time, for example five minutes.

The invention also provides a keyboard cover comprising a photosensitizer. In such a case, the computer keyboard need not itself comprise the photosensitizer and may merely be provided with an internal light source. The keyboard cover may thus be placed over the keyboard when not in use and the light source in the keyboard can be used to activate the photosensitizer. The keyboard cover could then be replaced on a regular basis (for example daily, weekly, etc.).

The keyboard cover can be manufactured by spraying or painting the photosensitizer onto cling film or a solid translucent pad.

The photosensitizer may comprise nanoparticles, preferably metallic nanoparticles, which have been found to increase the antimicrobial effect. Gold or silver nanoparticles have been found to be particularly effective. Preferably they are charge stabilized.

The photosensitizer may comprise a metallic nanoparticle-ligand-photosensitizer conjugate. Preferably, the photosensitizer is directly bound, by the ligand, to ligand-stabilized nanoparticles. The ligand is preferably a water-solubilizing ligand and the metallic nanoparticles and photosensitizer are preferably chosen such that the conjugate generates singlet oxygen and/or free radicals.

### BRIEF DESCRIPTION OF THE DRAWINGS

The invention will now be further described, by way of non-limitative example only, with reference to the accompanying schematic drawings, in which:

FIG. 1 shows a computer keyboard being illuminated by an external source of electromagnetic radiation is accordance with the present invention;

FIG. 2 shows a computer keyboard having internal sources of electromagnetic radiation in accordance with the present invention;

FIG. 3 shows a key for a computer keyboard with an optical fibre and antimicrobial coating attached thereto;

FIG. 4 shows a computer mouse having an internal source of electromagnetic radiation in accordance with the present invention; and

FIG. 5 shows a laptop computer in accordance with the present invention.

FIG. 6 shows a computer input device cover in accordance with the present invention.

### DETAILED DESCRIPTION OF THE INVENTION

The invention in one aspect comprises computer devices, preferably computer input devices. A stand-alone computer keyboard, a computer mouse and a laptop computer are exemplified but other devices fall within the scope of the claims.

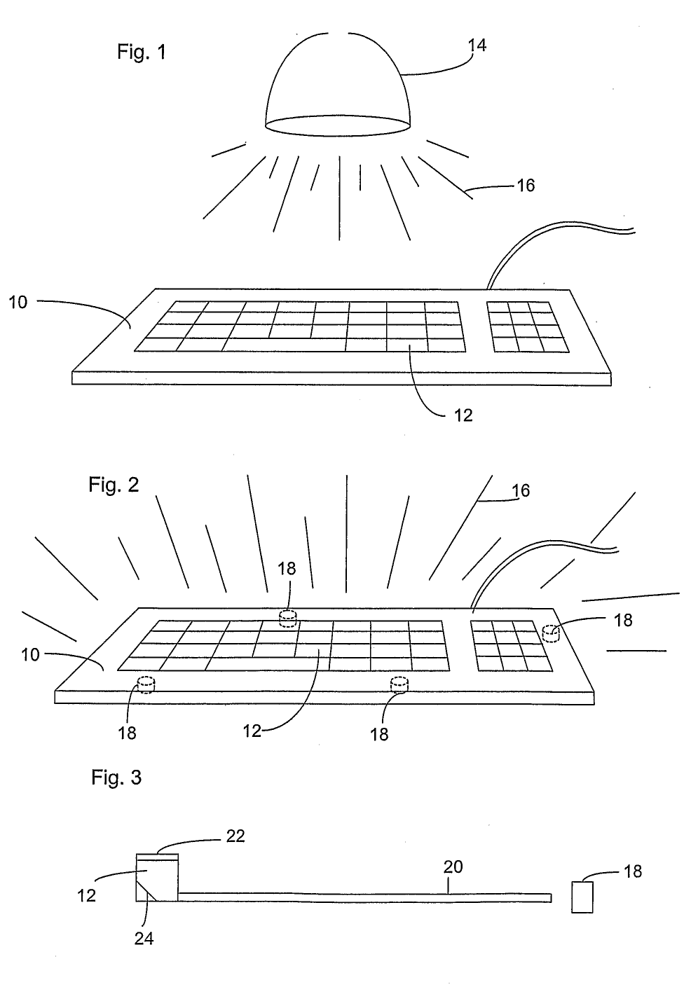

FIG. 1 shows a computer keyboard 10 having keys 12. A light source 14 illuminates the top surface of the keyboard 10 with beams of electromagnetic radiation 16. At least the keys 12 of the keyboard 10 are provided with a photosensitizer that provides an antimicrobial effect when activated by electromagnetic radiation. Preferably, the entire top surface of the keyboard is provided with such a photosensitizer. The photosensitizer is in this embodiment applied as a polymer coating to an already existing keyboard but it can alternatively or additionally be mixed in with the polymer used to create the keys and/or keyboard shell during manufacture.

Whenever the keyboard 10 is illuminated by electromagnetic radiation 16, the antimicrobial agent is activated and it is effective in killing microbes located in the vicinity. The photosensitizer used in this embodiment is toluidine blue mixed with cellulose acetate and the light source 14 emits light having a spectrum which includes a wavelength of 632 nm. This wavelength is the absorbance maximum of toluidine blue. In general, it is preferable that the light source 14 emits light which includes the wavelength at which the light activated antimicrobial agent is most effective.

The keyboard of FIG. 1 can be made according to conventional practices from plastic materials such as cellulose acetate. The keyboard can be made from opaque, transparent or partially transparent material. When transparent or partially transparent material is used, this is thought to provide an advantage in that electromagnetic radiation is more readily able to reach hard to access parts of the keys, such as the sides.

FIG. 2 shows a second embodiment of the invention in which the keyboard 10 is provided with a plurality of internal light sources 18. Four are shown in FIG. 2 although any number may in practice be used, including just one or two. A means to direct light from the light sources 18 to the keys 12 of the keyboard 10 is provided.

As shown in FIG. 2, such means may be the material of the keyboard itself, which can be made transparent or partially transparent such that light can reach the external surfaces of the keys. As shown schematically in FIG. 2 by light beams 16, the whole keyboard can be bathed in light in this manner. Alternatively or additionally, as shown in FIG. 3, a plurality of optical fibres 20 can be used to direct light to each key 12 or some of the keys. As shown in FIG. 3, light is transferred via optical fibre 20 to the key 12 and thereby to the antimicrobial photosensitizer layer 22. A reflector 24 may be utilized to more efficiently deliver light to the top of the key if desired.

The keyboard of FIG. 2 may be manufactured by making a keyboard in the conventional manner from transparent or partially transparent materials, the keyboard having one or more light sources therein and thereafter coating at least the keys of the keyboard with a photosensitizer coating. The keyboard may be arranged to emit light continuously to provide a continuous antimicrobial effect. In some situations it is preferable to use a controller to determine when the light is emitted but this is not essential to the invention (see later for details on the optional controller).

The light sources 14, 18 shown in FIGS. 1 and 2 can be any light source which is effective to activate the photosensitizer. Ideally, the light used will have a wavelength identical to the absorbance maximum of the light activated antimicrobial agent. For example, if the light activated antimicrobial agent is toluidine blue, light having a wavelength of 632 nm is preferred. Light sources 14, 18 can comprise a laser, a laser diode, one or more light-emitting diodes or a polychromatic light source with or without an appropriate filter.

The embodiment of FIGS. 2 and/or 3 may be modified so as not to include the photosensitizer as part of the keyboard itself. Rather, the photosensitizer can be comprised in a keyboard cover which is placed over the keyboard. The internal light source can then be used to irradiate the keyboard cover and the photosensitizer on the keyboard cover will accordingly kill microbes on the keys.

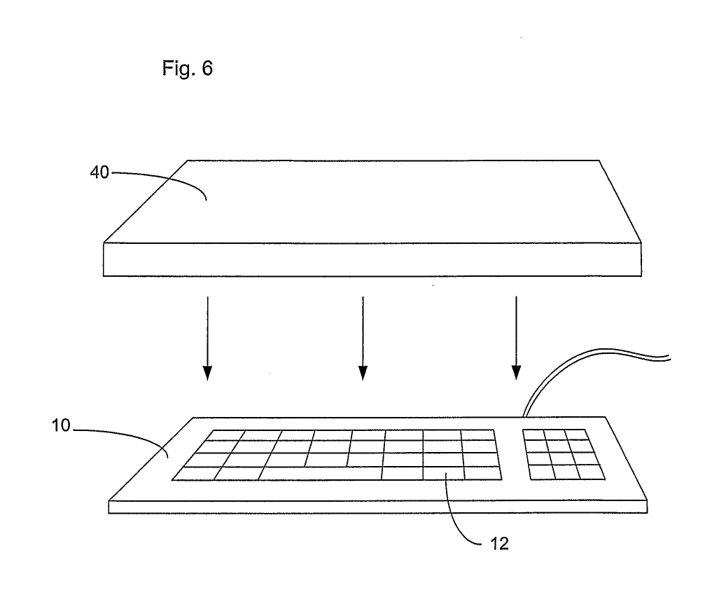

The keyboard cover may be manufactured from cling film or a solid translucent pad that is manufactured to incorporate the photosensitizer (and optional nanoparticles or conjugate—please see later) or which has painted or sprayed onto it the photosensitizer. The cover may be such as to be placed on the keyboard when not in use or may be flexible to allow use of the keyboard while the cover is in place. An example of such a cover 40 for a keyboard is shown in FIG. 6. The arrows show how the cover is attached to the keyboard. The keyboard cover is a particularly preferred embodiment of the invention because it can be replaced regularly. Heavily used keyboards may be subject to deposits building up on the keys. Thus, the embodiment of the present invention in which the keyboard cover is designed to be continually placed over the keyboard during use such that deposits build up on the keyboard cover rather than on the keys is beneficial because the keyboard cover can be simply replaced when the deposits have built up to an extent that the killing mechanism is not effective. Such a keyboard cover can be a flexible plastic film that incorporates the photosensitizer, possibly together with nanoparticles or in the form of a nanoparticle-ligand-photosensitizer conjugate. The cover can be used with a standard keyboard or with the light emitting keyboard shown in FIG. 2.

The present invention also includes covers for other input devices such as computer mice and touchscreens, such covers being similar to the keyboard cover described above but being shaped appropriate for their use.

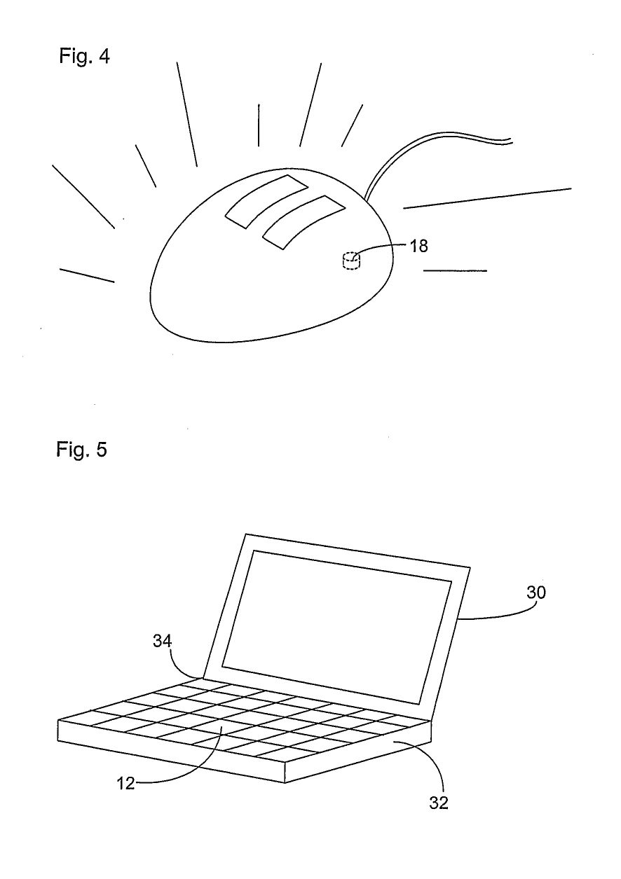

FIG. 4 shows a computer mouse in accordance with the invention. The plastic used to make the mouse is preferably transparent or partially transparent. An internal light source 18 is provided which illuminates the surface of the mouse that comes into contact with the user's hands to activate the photosensitizer polymer thereon. As with the keyboard, the photosensitizer may be embedded in the polymer used to manufacture the mouse or can be applied as a coating. Some computer mice already use light sources as part of the position detection mechanism. One advantageous possibility is to utilize this same light source also as the photosensitizer activation illumination. This minimizes the number of extra components required to effect the present invention. Of course, the mouse may be made of conventional non-transparent materials in which case an external light source similar to that referenced 14 in FIG. 1 can be provided to activate the antimicrobial photosensitizer.

FIG. 5 shows a laptop computer of the type in which the display screen 30 is attached to the computer base section 32 via a hinge 34 such that the display screen 30 closes down over the base section 32 to provide a more portable arrangement. The base section 32 has a plurality of keys 12. The keys 12 of the base section 32 can be coated or manufactured with the photosensitizer in a way similar to the previously described embodiments. The photosensitizer can be selected such that it is activated by light emitted by the display screen 30. A controller can be incorporated which causes the display screen 30 to emit light of appropriate wavelength for a period of time after the screen 30 has been closed down over the base section 32. This light will bathe the keys 12 of the keyboard to activate the antimicrobial agent. In this way any microbes that may have built up during use of the laptop computer can be killed and no special light sources are required as the display screen 30 can provide all the necessary light directly in the vicinity of the keyboard keys 12. Alternatively or additionally, further light sources 14, 18 may be provided as in the other embodiments.

Each of the above-described embodiments of computer devices can be provided with their own controller. This controller can be used to determine the time period for which the light sources 14, 18, 30 are operated to provide the antimicrobial effect. The controller can be arranged to initiate the supply of light to the photosensitizer at various times. For example, the controller can be arranged to initiate 1 minute bursts of light for every hour of time while the computer to which the input device is attached is turned on. The controller may initiate the supply of light at times when the input device is being actively used. For example, when the input device is a keyboard, light can be supplied (via an optical fibre if desired) to a key 12 whenever that key is depressed. If this is considered too distracting to the user, the controller can arrange to initiate the supply of light whenever the input device has been inactive for a certain period of time, for example 5 minutes. Another alternative is to arrange for light to be supplied whenever the computer to which the input device is attached is turned off or when the user has finished using the computer for the day.

The photosensitizer is suitably chosen from porphyrins (e.g. haematoporphyrin derivatives, deuteroporphyrin), phthalocyanines (e.g. zinc, silicon and aluminium phthalocyanines), chlorins (e.g. tin chlorin e6, poly-lysine derivatives of tin chlorin e6, m-tetrahydroxyphenyl chlorin, benzoporphyrin derivatives, tin etiopurpurin), bacteriochlorins, phenothiaziniums (e.g. toluidine blue, methylene blue, dimethylmethylene blue), phenazines (e.g. neutral red), acridines (e.g. acriflavine, proflavin, acridine orange, aminacrine), texaphyrins, cyanines (e.g. merocyanine 540), anthracyclins (e.g. adriamycin and epirubicin), pheophorbides, sapphyrins, fullerene, halogenated xanthenes (e.g. rose bengal), perylenequinonoid pigments (e.g. hypericin, hypocrellin), gilvocarcins, terthiophenes, benzophenanthridines, psoralens and riboflavin. Other possibilities are arianor steel blue, tryptan blue, crystal violet, azure blue cert, azure B chloride, azure 2, azure A chloride, azure B tetrafluoroborate, thionin, azure A eosinate, azure B eosinate, azure mix sicc. and azure II eosinate.

Particularly preferred photosensitizers are toluidine blue O, methylene blue, dihaematoporphyrin ester, tin chlorin e6, indocyanine green or nile blue sulphate. Preferably, the photosensitizer is toluidine blue O, methylene blue or tin chlorin e6. Most preferably, the photosensitizer is methylene blue or toluidine blue O.

The photosensitizer is preferably selected for its ability to kill MRSA, epidemic strains of MRSA (EMRSA), vancomycin-resistant Staphylococcus aureus (VRSA), hetero-VRSA, community-acquired MRSA (CA-MRSA), Clostridium difficile, Acinetobacter spp. and Pseudomonas aeruginosa, as well as viruses and pathogenic fungi.

The source of light may be any device or biological system able to generate monochromatic or polychromatic light, coherent or incoherent light, especially visible white light. Examples include fluorescent light source, laser, light emitting diode, arc lamp, halogen lamp, incandescent lamp or an emitter of bioluminescence or chemiluminescence. Sunlight may also be suitable. The wavelength of light emitted by the light source may be from 200 to 1060 nm, preferably from 400 to 750 nm. A suitable laser may have a power of from 1 mW to 100 W. The light dose for laser irradiation is suitably from 5 to 333 J cm⁻², preferably from 5 to 30 J cm⁻² for laser light. For white light irradiation, a suitable dose is from 0.01 to 100 J/cm², preferably from 0.1 to 20 J/cm², more preferably from 3 to 10 J/cm². The duration of irradiation can suitably be from 1 second to 15 minutes, preferably from 1 to 5 minutes.

When the photosensitizer is applied as a coating, it may be applied by painting, spreading, spraying or any other conventional technique. It may thereafter be dried or allowed to dry/harden.

### Photosensitizer-Nanoparticle Mixtures

Any of the photosensitizers disclosed herein may be enhanced in their antimicrobial activity by mixing the photosensitizers with (preferably metallic) nanoparticles, such as gold or silver nanoparticles. This “photosensitizer” above may be read as “photosensitizer and nanoparticles”.

The term “nanoparticles” is generally understood to mean particles having a diameter of from 1 to 100 nm. Preferably, the nanoparticles used in the present invention have a diameter of from 1 to 30 nm. In one embodiment, the nanoparticles preferably have a diameter of from 2 to 5 nm. In another embodiment, the nanoparticles preferably have a diameter of from 10 to 25 nm, more preferably 15 to 20 nm.

Nanoparticles typically, but not exclusively, comprise metals. They may also comprise alloys of two or more metals, or more complex structures such as core-shell particles, rods, stars, spheres or sheets. A core-shell particle may typically comprise a core of one substance, such as a metal or metal oxide or silica, surrounded by a shell of another substance, such as a metal, metal oxide or metal selenide. The term “metallic” as used herein is intended to encompass all such structures having a metallic outer surface.

In a preferred embodiment, the outer surface of the metallic nanoparticles used comprise a main group metal or transition metal, such as cobalt. More preferably, the metallic nanoparticles are gold, silver or copper nanoparticles, or alloys of two or more of these metals. Most preferably, the nanoparticles are gold nanoparticles. Preferably, the nanoparticles are charge stabilized.

Without wishing to be bound by theory, it is thought that the photosensitizer and nanoparticles are associated via dative covalent bonds, wherein the electrons are provided by, for example, S or N moieties on the photosensitizer.

A particularly preferred embodiment utilises a photosensitizer of methylene blue or toluidine blue mixed with gold nanoparticles.

The mixture of photosensitizer and nanoparticles is preferably prepared in the form of a solution. Such a solution may be produced by contacting a solution of (preferably charge-stabilized) metallic nanoparticles with a solution of photosensitizer. The mixtures are contacted at any suitable temperature, for example between the freezing point and boiling point of the solvent employed (or at a temperature at which both solutions are liquid if different solvents are employed). However, if the temperature is too high, the nanoparticle solution is likely to become unstable. Preferably, the solutions are contacted at or about room temperature.

A preferred method involves mixing a solution of metallic nanoparticles with a solution of photosensitizer and allowing it to stand at room temperature for at least 10 minutes, preferably between 10 minutes and 1 hour, more preferably between 15 and 20 minutes.

Typically, the metallic nanoparticle solution and/or the photosensitizer solution is a solution in a polar solvent, preferably an aqueous solution, such as in water or phosphate buffered saline solution. More preferably, both the nanoparticle and photosensitizer solutions are aqueous.

The two solutions may be mixed in any proportion, such that the desired concentration is achieved in the mixed solution. Typically, the initial concentrations of each solution are selected as required so that the desired concentration in the mixed solution is achieved when equal volumes of metallic nanoparticle solution and photosensitizer solution are mixed together.

The final concentration of the nanoparticles in the mixture is preferably from 1×10¹¹ to 5×10¹⁵ particles/ml, more preferably from 3×10¹¹ to 1×10¹⁵ particles/ml. In order to obtain such a final concentration, the initial concentration of the nanoparticle solution is typically from 1×10¹² to 1×10¹⁶ particles/ml. If the nanoparticle solution as prepared, or as obtained commercially, is of higher concentration than this, it may be necessary to dilute the nanoparticle solution before mixing with the photosensitizer. For example, an original nanoparticle solution containing 1×10¹⁴ or 1×10¹⁵ particles/ml maybe diluted 1:10 to 1:100, such that the concentration before mixing with the photosensitizer solution is from 1×10¹² to 1×10¹⁴.

The initial concentration of photosensitizer solution is preferably chosen such that when mixed with the nanoparticle solution, the final concentration of photosensitizer at the treatment site is from 5 to 100 mM, more preferably from 20 to 50 mM.

The photosensitizer and nanoparticle solution may be incorporated into the computer devices in the same way as the photosensitizer described above may be incorporated. For example, it may be applied as a coating by painting, spreading or spraying and may be dried or allowed to dry naturally. It can also be mixed with a plastics material such as cellulose acetate to create an antimicrobial plastic. The computer device can then be made from this plastics material or this plastics material can be coated over the surface of the computer device to be treated. Thus, in one embodiment, a computer device can be coated with a mixture of cellulose acetate, photosensitizer and nanoparticles. The steps of preparing the photosensitizer-nanoparticle mixture as a solution are merely preferable and do not form an essential aspect of the invention.

The efficacy of the photosensitizer-nanoparticle combination as an antimicrobial depends on many factors. The choice of nanoparticle type, choice of photosensitizer, nanoparticle size, concentration of nanoparticles and concentration of photosensitizer may all influence antimicrobial activity. Thus individual combinations may have particularly advantageous effects. For example, the following combinations have been found particularly effective against Staphylococcus aureus:
2 nm diameter gold nanoparticles at a concentration of 4×10¹³ particles/ml with toluidine blue O at a concentration of 20 mM.
15 nm diameter gold nanoparticles at a concentration of 1×10¹⁴ to 1×10¹⁵ particles/ml with toluidine blue O at a concentration of 20 to 50 mM.
2 nm diameter gold nanoparticles at a concentration of 4×10¹¹ to 4×10¹³ particles/ml with methylene blue at a concentration of 20 mM.
15 nm diameter gold nanoparticles at a concentration of 1×10¹³ to 1×10¹⁵ particles/ml with methylene blue at a concentration of 20 mM.
2 nm diameter gold nanoparticles at a concentration of 4×10¹¹ particles/ml with tin chlorin e6 at a concentration of 20 mg/ml.
2 nm gold nanoparticles at a concentration of 4×10¹³ particles/ml with nile blue sulphate at a concentration of 20 to 50 mM.

### Metallic Nanoparticle-Ligand-Photosensitizer Conjugates

The effectiveness of the photosensitizer as an anti-microbial agent can be enhanced by incorporating the photosensitizer into a nanoparticle-ligand-photosensitizer conjugate. Thus, the term “photosensitizer” above may be read as “metallic nanoparticle-ligand-photosensitizer conjugate”.

The metallic nanoparticles of the present invention can be chosen such that, when attached via the ligand to the photosensitizer to form the conjugate, the conjugate generates singlet oxygen and/or free radicals. Preferably, the conjugate generates both singlet oxygen and free radicals.

Singlet oxygen generation may be measured by assay: several such methods are known to those skilled in the art, for example, photoluminescence. Free radical generation may be measured using electron proton resonance (EPR).

Examples of metallic nanoparticles that may be suitable are nanoparticles having a diameter of greater than about 2 nm which exhibit plasmon resonance in the wavelength band of about 200 to about 1600 nm, i.e. covering the visible to near infrared bands. The plasmon resonance may be measured by UV spectroscopy. It may be seen for both the free and conjugated nanoparticle. For antimicrobial applications, preferable nanoparticles will exhibit plasmon resonance at wavelengths of from about 500 to about 600 nm. Gold nanoparticles, for example, exhibit plasmon resonance in this range.

Another property which may be used to help select a suitable nanoparticle is the molar extinction coefficient of the conjugated photosensitizer. When a photosensitizer is conjugated via a ligand to a suitable nanoparticle, the extinction coefficient of the photosensitizer may be enhanced, compared to the extinction coefficient that would be expected based on an equivalent concentration of the photosensitizer alone. Without wishing to be bound by theory, it is thought that this enhancement occurs because the photosensitizer coordinates to the surface of the nanoparticle. Thus, in order to select suitable nanoparticles, the extinction coefficient of the conjugate could be measured, using a spectrophotometer. Any enhancement is acceptable. Typically, the extinction coefficient may range anywhere from about 2 to about 30 times or more; from about 5 to about 30 times or more; from about 10 to about 30 times or more and from about 20 to about 30 times or more, compared to what is expected based on the same concentration of the unconjugated photosensitizer.

In a preferred embodiment, the outer surface of the nanoparticles of the present invention comprises gold, silver or copper. More preferably, the nanoparticles comprise gold, silver or copper, or alloys of two or more of these metals, such as gold/silver, gold/copper or gold/silver/copper. Suitable alloys may also contain other metals, such as gold/silver/aluminium.

In another embodiment, the nanoparticles described in the preceding paragraph comprise core-shell particles. It is possible for such core-shell particles to comprise a magnetic core or magnetic layer. An example of such a magnetic core-shell particle is a particle having a magnetic core and an outer shell which comprises gold.

Most preferably, the nanoparticles are gold nanoparticles.

The ligand of the metallic nanoparticle-ligand-photosensitizer conjugate is preferably a water-solubilizing ligand. This means that the conjugate as a whole is water soluble at a concentration of at least about 1×10⁻⁸ M (mol dm⁻³) at room temperature (25° C). Preferably, the conjugate is water soluble at a concentration of at least about 1×10⁻⁷ M, more preferably at least about 1×10⁻⁶ M.

The concentration for determining water solubility may be measured by any appropriate method. Suitable methods include UV absorption, inductively coupled plasma mass spectrometry (ICP-MS), SQUID (superconducting quantum interference device) magnetometry, EPR or Raman spectroscopy.

Examples of suitable ligands are water-solubilizing ligands chosen from sulfur ligands, such as thiols (alkanethiols and aromatic thiols), xanthates, disulfides, dithiols, trithiols, thioethers, polythioethers, tetradentate thioethers, thioaldehydes, thioketones, thion acids, thion esters, thioamides, thioacyl halides, sulfoxides, sulfenic acids, sulfenyl halides, isothiocyanates, isothioureas or dithiocarbamates; selenium ligands, such as selenols (aliphatic or aromatic), selenides, diselenides, dialkyl-diselenides (for example octaneselenol-nanoparticle is obtained from dioctyl-diselenide), selenoxides, selenic acids or selenyl halides; tellurium ligands, such as tellurols (aliphatic or aromatic), tellurides or ditellurides; phosphorus ligands, such as phosphines or phosphine oxides; nitrogen ligands, such as alkanolamines or aminoacids; and other ligands such as carboxylate ligands (e.g. myristate), isocyanide, acetone and iodine.

Examples of preferred water-solubilizing ligands are 3-mercaptopropionic acid, 4-mercaptobutyric acid, 3-mercapto-1,2-propanediol, cysteine, methionine, thiomalate, 2-mercaptobenzoic acid, 3-mercaptobenzoic acid, 4-mercaptobenzoic acid, tiopronin, selenomethionine, 1-thio-beta-D-glucose, glutathione and ITCAE pentapeptide.

A photosensitizer is a compound that can be excited by light of a specific wavelength. Thus, such a compound may have an absorption band in the ultraviolet, visible or infrared portion of the electromagnetic spectrum and, when the compound absorbs radiation within that band, it generates cytotoxic species, thereby exerting an antimicrobial effect. The effect may be due to creation of singlet oxygen but the invention is not limited to photosensitizers that exhibit antimicrobial effects through creation of singlet oxygen. In particular, the photosensitizer may generate free radicals, instead of, or as well as, generating singlet oxygen.

It is a feature of the present invention that the photosensitizer is chosen such that, when attached to the metallic nanoparticle-ligand core to form the conjugate, the conjugate generates singlet oxygen and/or free radicals. Preferably, the conjugated photosensitizer generates both singlet oxygen and free radicals. Singlet oxygen and free radical generation may be measured as described above.

It is preferable that the photosensitizer is non-toxic to humans and animals at the concentrations employed in the present invention. It is also preferable that the photosensitizer demonstrates antimicrobial activity when exposed to visible light. The photosensitizer is suitably chosen from porphyrins (e.g. haematoporphyrin derivatives, deuteroporphyrin), phthalocyanines (e.g. zinc, silicon and aluminium phthalocyanines), chlorins (e.g. tin chlorin e6, poly-lysine derivatives of tin chlorin e6, m-tetrahydroxyphenyl chlorin, benzoporphyrin derivatives, tin etiopurpurin), bacteriochlorins, phenothiaziniums (e.g. toluidine blue O, methylene blue, dimethylmethylene blue), phenazines (e.g. neutral red), acridines (e.g. acriflavine, proflavin, acridine orange, aminacrine), texaphyrins, cyanines (e.g. merocyanine 540), anthracyclins (e.g. adriamycin and epirubicin), pheophorbides, sapphyrins, fullerene, halogenated xanthenes (e.g. rose bengal), perylenequinonoid pigments (e.g. hypericin, hypocrellin), gilvocarcins, terthiophenes, benzophenanthridines, psoralens and riboflavin. Other possibilities are indocyanine green, nile blue sulphate, arianor steel blue, tryptan blue, crystal violet, azure blue cert, azure B chloride, azure 2, azure A chloride, azure B tetrafluoroborate, thionin, azure A eosinate, azure B eosinate, azure mix sicc. and azure II eosinate.

In one embodiment, particularly preferred photosensitizers are toluidine blue O (TBO), methylene blue, tin chlorin e6, indocyanine green or nile blue sulphate. Preferably, the photosensitizer is not a porphyrin. More preferably, the photosensitizer is toluidine blue O, methylene blue or tin chlorin e6. Most preferably, the photosensitizer is methylene blue or TBO.

The proportion of metallic nanoparticle:ligand:photosensitizer may vary. Typically, the nanoparticle comprises many atoms, only some of which have ligand molecules covalently bonded thereto. The number of photosensitizer molecules attached to each nanoparticle-ligand core may also vary. Typically, only some of the ligand molecules will have a photosensitizer molecule attached. For example, a preferred conjugate according to the present invention could have the composition Au₂₀₁Tiopronin₈₅TBO₉, Au₂₀₁Tiopronin₈₅TBO₁₁ or Au₂₀₁Tiopronin₈₅TBO₁₅.

The conjugate may also comprise further components. For example, it may have a targeting moiety associated with it. The targeting moiety can be associated with the conjugate via any suitable means, for example it may be attached to the nanoparticle core, to the ligand or to the photosensitizer. Such targeting moieties may be suitable, for example, for targeting specific microorganisms, or for targeting cancer cells. For example, they may be antibodies with specificity for the target organism or cancer cell. Other examples of targeting moieties include bacteriophages, protein A (targets Staphylococcus aureus) and bacterial cell-wall binding proteins or peptides.

The preferred conjugate mentioned above is an example of another aspect of the present invention. Thus the present invention also provides novel metallic nanoparticle-ligand-photosensitizer conjugates, wherein the metallic nanoparticle comprises gold, the ligand comprises tiopronin and the photosensitizer comprises (TBO).

In one embodiment, the novel conjugate preferably consists of gold-tiopronin-TBO.

Preferably, the novel conjugate comprises from about 5 to about 20 TBO groups per nanoparticle-ligand core.

The novel conjugates of the present invention have been found to demonstrate particularly effective antimicrobial properties. Thus all uses of conjugates as described herein apply to the novel conjugates.

### Process for Preparation of the Conjugates

The present invention provides a process for producing conjugates as described above. Such a process comprises the steps of:

(i) providing a nanoparticle-ligand core, comprising a nanoparticle having bonded thereto at least one ligand having first and second functional groups, wherein the ligand is bonded to the nanoparticle via the first functional group, and then

(ii) reacting the second functional group of at least one of said ligands with a functional group of a photosensitizer.

Preferred nanoparticles, ligands and photosensitizers for use in the process of the present invention are as described above. Preferably, both steps of the process are carried out in aqueous solution.

One embodiment of the process will now be illustrated by reference to the novel gold-tiopronin-TBO conjugates described above.

Typically, the nanoparticle-ligand core is prepared by a reaction based on the Brust reaction (Brust, M; Walker, M; Bethell, D; Schiffrin, D J; Whyman, R; J. Chem. Soc. Chem. Comm., 1994, 801-802). Such reactions are well known to those skilled in the art. However, in the case of a gold-tiopronin core, it is preferable to modify the usual reaction mixture, and the reaction is preferably executed in a methanol/acetic acid mixture, rather than in toluene. Furthermore, the amount of acetic acid should be controlled such that a final pH of about 5 is achieved after addition of sodium tetrahydroborate.

The nanoparticle-ligand core is preferably purified, for example by dialysis, before reaction with the photosensitizer.

Typically, the reaction between the nanoparticle-ligand core and photosensitizer takes place in an aqueous medium. In one embodiment, a catalyst can be used. For example, 1-[3-(dimethylamino)-propyl]-3]ethyl-carbodiimide (EDC) can be used to catalyse reactions between tiopronin carboxylic acid groups and an aromatic amine-containing TBO molecule. N-hydroxysulfosuccinimide sodium salt may be included in the reaction mixture to improve the efficiency of the reaction.

Typically, the reaction feed ratio of photosensitizer to nanoparticle-ligand core is such that it provides from about 0.5 to about 2 functional groups on the photosensitizer per “second functional group” on the ligand. Preferably, the ratio is about 1:1. Such a ratio provides conjugates with from about 5 to about 20 molecules of photosensitizer per core, as described above.

Conjugates prepared by a process according to the present invention are typically stable, showing no decomposition over a period of months.

### Light Activation

The antimicrobial effect of the conjugates is activated by exposure to a light source. In one embodiment, the conjugates may be exposed to a light source comprising radiation having a wavelength, or a range of wavelengths, within the range of wavelengths absorbed by the conjugated photosensitizer, preferably near or corresponding to the wavelength of maximum absorption of the photosensitizer (λₘₐₓ). In one embodiment, it is preferred that the conjugate demonstrates antimicrobial activity when exposed to visible light, i.e. λₘₐₓ is between about 380 and about 780 nm.

If the conjugate comprises a targeting moiety, this may bind to the microbes of interest, enhancing the antimicrobial effect. When the nanoparticle of such a targeted conjugate comprises core-shell particles having a magnetic core, it may be possible to remove the conjugates, before or after the step of exposure to a light source, by using a magnetic field. Such a step would also remove microbes attached to the conjugate via the targeting moiety, thereby “cleaning” the treated site.

The conjugates may be applied as a coating by painting, spreading or spraying and may be dried or allowed to dry naturally. They can also be mixed with a plastics material such as cellulose acetate to create an antimicrobial plastic. Such a plastics material could be used to manufacture articles, such as computer input devices, or as antimicrobial coverings to be wrapped or coated over the surface of the article to be treated. Thus, in one embodiment, as described above, an article such as a computer input device could be coated or covered with a mixture of cellulose acetate and the conjugate.

The computer devices of the present invention may find application in hospitals and other places where microbiological cleanliness is necessary, for example food processing facilities, dining areas or play areas. Use in abattoirs is also envisaged.

### Example of Effectiveness of Photosensitizer

The activity of a simple cellulose acetate polymer coating against MRSA E-16 was compared to the activity of a coating comprising cellulose acetate containing 25 μM toluidine blue. A suspension of MRSA in Brain Heart Infusion (BHI) broth was inoculated onto the keys from a computer keyboard and the experiment was repeated on consecutive days (Experiments A and B). The tables below show the number of viable bacteria on the keys both initially and after 1 hour. It can be seen that the number of bacteria surviving on the computer keys with the toluidine blue/cellulose acetate coating is much lower than on the keys with the clear (cellulose acetate) coating.

Experiment A

| | | Number of Viable | |
|---|---|---|---|
| | | Bacteria | |
| Synthetic Sample Type | Sample Number | 0 Hours | 1 Hour |
| Keys with toluidine blue coating | B1 | 50 | 0 |
| | B2 | 31 | 1 |
| | B3 | 37 | 3 |
| | B4 | 26 | 1 |
| | B5 | 46 | 1 |
| | B6 | 49 | 3 |
| Keys with polymer coating | C1 | 66 | 4 |
| | C2 | 50 | 10 |
| | C3 | 48 | 10 |
| | C4 | 44 | 14 |
| | C5 | 35 | 7 |
| | C6 | 54 | 1 |

Average No. bacteria with toluidine blue = 1.5
Average No. bacteria without toluidine blue = 7.67

Experiment B

| | | Number of Viable | |
|---|---|---|---|
| | | Bacteria | |
| Synthetic Sample Type | Sample Number | 0 Hours | 1 Hour |
| Keys with toluidine blue coating | B1 | 36 | 0 |
| | B2 | 58 | 0 |
| | B3 | 37 | 0 |
| | B4 | 24 | 0 |
| | B5 | 61 | 2 |
| | B6 | 55 | 1 |
| Keys with polymer coating | C1 | 48 | 3 |
| | C2 | 52 | 3 |
| | C3 | 40 | 2 |
| | C4 | 51 | 1 |
| | C5 | 65 | 11 |
| | C6 | 47 | 17 |

Average No. bacteria with toluidine blue = 0.5
Average No. bacteria without toluidine blue = 6.17

### Example of Effectiveness of Photosensitizer-Nanoparticle Mixtures

### Example 1

Gold nanoparticles (2.0 nm diameter; British Biocell International) in water (15×10¹³ particles per ml) were mixed with an equal volume of an aqueous solution of toluidine blue O (40 μM) and left at room temperature for 15 minutes. 100 μl of the gold-TB solution was added to 100 μl of a suspension of Staphylococcus aureus NCTC 6571 in phosphate buffered saline (PBS) and this was irradiated with white light from an 18 W fluorescent white lamp for 10 minutes. Controls consisted of:
(i) TB (final concentration=10 μM) and bacteria, irradiated for the same period of time,
(ii) nanogold (diluted 1:1 with water) and bacteria, irradiated for the same period of time,
(iii) bacteria without TB or nanogold, not irradiated (“control”).

After irradiation, the number of surviving bacteria was determined by viable counting.

The results of the experiments (carried out twice with duplicate counts on each occasion) are shown in Table 1. The gold nanoparticles alone when irradiated did not achieve significant killing of the bacteria. The TB-gold achieved approximately a one log greater kill than the TB alone—99.3% kill as opposed to a 93.7% kill. Note that the TB concentration and light energy dose used were designed to give sub-optimal kills so that differences in efficacy of the TB and the TB-nanogold could be discerned. Preliminary experiments using 30 minutes light exposure achieved total kills of the bacterial suspensions in both cases.

TABLE 1

| Sample | S. aureus (cfu/ml) | % Kill |
|---|---|---|
| Control | 135000000 | — |
| Gold only | 81000000 | 40.0 |
| TB only | 8570000 | 93.7 |
| Mixture (L + TB + G+) | 983000 | 99.3 |

### Example 2

### Production of Water-Soluble Gold Nanoparticles

HAuCl₄.3H₂O (42 mg, 0.11 mmol) was dissolved in deionised water (25 ml) to form solution A (˜5 mM). Na₃C₆H₅O₇.2H₂O (125 mg, 0.43 mmol) was dissolved in deionised water (25 ml) to give solution B (˜20 mM). Solution A (1 ml) was stirred with deionised water (18 ml) and boiled for 2 min. Then solution B (1 ml) was added dropwise over a period of approximately 50 sec. causing the color change from clear to blue to pink/purple. After a farther 1 min. of heating, the solution was left to cool to room temperature.

Two batches of nanogold particles were used for subsequent antibacterial assays—these are designated NN1 and NN2.

The absorption spectrum of NN2 showed the wavelength of maximum absorption, λₘₐₓ to be 527 nm. Batch NN1 had a λₘₐₓ of 522 nm.

Particle size analysis (position of UV plasmon absorption band measured using transmission electron microscope) of batch NN1 gave an average diameter of 14.76±2.34 nm.

### Effect of Concentration of Photosensitizer

Gold nanoparticles of approximately 15 nm in diameter (batches NN1 and NN2 above) were mixed with an equal volume of aqueous toluidine blue O (TB) and left at room temperature for 15 minutes. TB was used at a final concentration of 1, 5, 10, 20 or 50 μM.

100 μl of the TB-gold mixture was added to 100 μl of a suspension of Staphylococcus aureus NCTC 6571 in phosphate buffered saline (PBS) (adjusted to an optical density of 0.05), and samples were irradiated with a fluorescent white light (28 W) for 10 minutes. S. aureus+TB only, and S. aureus+PBS, without photosensitizer or nanogold were used as controls. The final concentration of nanogold used was 1×10¹⁵ particles/ml.

After irradiation, the numbers of surviving bacteria were enumerated by viable counting. The results are shown in Table 2 below.

In the case of the 15 nm nanogold, there was little enhancement of lethal photosensitization (compared with that achieved when TB was used in the absence of nanogold) when the TB concentration was 1 μM whereas enhancement was evident using higher TB concentrations of 5, 10 and 20 μM. Enhancement was greatest using 10 and 20 μM TB.

Enhancement appears to be dependent on the ratio of TB to nanogold. There was little enhancement of lethal photosensitization when the TB concentration was 10 or 100 μM, whereas enhancement was greatest using TB concentrations of 20 and 50 μM.

### Example 3

The method of Example 2 was repeated using gold nanoparticles of 2 nm diameter (British Biocell International). The final concentration of nanogold used was 4×10¹³ particles/ml. TB was used at a final concentration of 10, 20 or 50 μM. The results are shown in Table 2 below.

When the 2 nm nanogold particles were used, enhancement of lethal photosensitization was evident using 20 μM TB but not when either 10 μM or 50 μM TB was used.

### Example 4

### Effect of Concentration of Gold Nanoparticles

Experiments were performed as for Example 3, with the following modifications: Prior to mixing with the photosensitizer, the gold nanoparticles were either left undiluted, or diluted 1 in 10 or 1 in 100 in sterile, distilled water. The nanoparticles were then added to TB (final concentration 20 μM).

The samples were then illuminated for 30 seconds using a fibre optic white light source (Schott KL200). The surviving bacteria were enumerated by viable counting as before. The results are shown in Table 2 below.

When the nanoparticles were diluted 1 in 10 a greater enhancement was achieved compared with that obtained using undiluted nanogold

### Example 5

Example 4 was repeated using methylene blue (MB; 20 μM) as the photosensitizer. The results are shown in Table 2 below. The enhancement achieved by the nanogold with a larger particle size (15 nm) was not increased when the nanogold concentration was decreased.

### Example 6

Example 5 was repeated using 2 nm gold nanoparticles (British Biocell International). The results are shown in Table 2 below. Diluting the 2 nm gold nanoparticles enhanced the killing of S. aureus slightly when used in combination with methylene blue.

### Example 7

Example 6 was repeated using tin chlorin e6 (SnCe6; 20 μg/ml) as the photosensitizer. The illumination time was 10 minutes. The results are shown in Table 2 below.

Diluting the 2 nm gold nanoparticles enhanced the killing of S. aureus when used in combination with tin chlorin e6.

### Example 8

Example 3 was repeated using nile blue sulphate as the photosensitizer. Samples were illuminated for 30 minutes. The results are shown in Table 2 below.

TABLE 2

| | | Concentration of | Nanoparticle | Nanoparticle | |
|---|---|---|---|---|---|
| | | photosensitiser¹ | size | concentration¹ | |
| Example | Photosensitiser | (mM) | (nm) | (particles/ml) | Result² |
| 2 | Toluidine blue | 1 | 15 | 1 × 10¹⁵ | — |
| | | 5 | | | * |
| | | 10 | | | **/*** |
| | | 20 | | | **** |
| | | 50 | | | **** |
| | | 100 | | | ** |
| 3 | Toluidine blue | 10 | 2 | 4 × 10¹³ | * |
| | | 20 | | | **** |
| | | 50 | | | * |
| 4 | Toluidine blue | 20 | 15 | 1 × 10¹⁵ | *** |
| | | | | 1 × 10¹⁴ | **** |
| 5 | Methylene blue | 20 | 15 | 1 × 10¹⁵ | **** |
| | | | | 1 × 10¹⁴ | **** |
| | | | | 1 × 10¹³ | **** |
| 6 | Methylene blue | 20 | 2 | 4 × 10¹³ | **** |
| | | | | 4 × 10¹² | **** |
| | | | | 4 × 10¹¹ | **** |
| 7 | Tin chlorine6 | 20³ | 2 | 4 × 10¹³ | — |
| | | | | 4 × 10¹² | ** |
| | | | | 4 × 10¹¹ | *** |
| 8 | Nile blue sulphate | 10 | 2 | 4 × 10¹³ | *** |
| | | 20 | | | **** |
| | | 50 | | | **** |

¹concentration in mixed solution
²Key: — less than 50% kill; *50-90% kill; **90-95% kill; ***95-99% kill; ****99-100% kill
³concentration in m/ml

Examples of Conjugates and their Effectiveness

Please note that these examples are for the purpose of illustration only and are not to be construed as limiting the scope of the invention in any way.

### Example 1

### Synthesis of TBO-tiopronin-gold Nanoparticle Conjugates

### Chemicals

Hydrogen tetrachloroaurate (tetrachloroauric acid; HAuCl₄.3H₂O, 99.99%), N-(2-mercaptopropionyl)glycine (tiopronin, 99%) and sodium borohydride (99%) were purchased from Aldrich. Toluidine Blue O (“TBO”, 90%) was purchased from Acros Organics. Buffers were prepared according to standard laboratory procedure. All other chemicals were reagent grade and used as received.

The synthesis of the conjugates involved two steps:

(1) Synthesis of tiopronin-gold nanoparticle conjugate; and

(2) Preparation of TBO-tiopronin-gold nanoparticle conjugate.

### Synthesis of Tiopronin-gold Nanoparticle Conjugate

Tetrachloroauric acid (0.62 g; 1.57 mmol) and N-(2-mercaptopropionyl)glycine (tiopronin, 0.77 g; 4.72 mmol) were dissolved in 6:1 methanol/acetic acid (70 mL) giving a ruby red solution. Sodium borohydride (NaBH₄, 1.21 g; 32 mmol) in water (30 mL) was added with rapid stirring, whereupon the solution temperature immediately rose from 24° C. (room temperature) to 44° C. (returning to room temperature in ca. 15 min). Meanwhile, the solution pH increased from its initial 1.2 value to 5.1. The black suspension that was formed was stirred for an additional 30 min after cooling, and the solvent was then removed under vacuum at ≦40° C.

The crude reaction product was completely insoluble in methanol but quite soluble in water. It was purified by dialysis, in which the pH of the crude product dissolved in water (80 mL) was adjusted to 1 by dropwise addition of concentrated hydrochloric acid (HCl). This solution was loaded into 20 cm segments of cellulose ester dialysis membrane (Spectra/Por CE, MWCO=12000), placed in a 4 L beaker of water, and stirred slowly, recharging with fresh water ca. every 12 hours over the course of 72 hours. The dark tiopronin-gold nanoparticle conjugate solution was collected from the dialysis tube, and the solvent was removed by freeze-drying. The product materials were found to be spectroscopically clean (¹H NMR in D₂O, 10 mg of sample: absence of signals due to unreacted thiol or disulfide and acetate byproducts). Elemental analysis of the dialysed tiopronin-gold nanoparticle conjugate gave the following. Anal. Found: C, 11.70; H, 1.65; N, 2.55; S, 5.73. Calcd for C₄₂₅H₆₈₀O₂₅₅N₈₅S₈₅Au₂₀₁: C, 9.56; H, 1.28; N, 2.23; O, 7.65; S, 5.11; Au, 74.17.

### Preparation of TBO-tiopronin-gold-nanoparticle Conjugate

Tiopronin-gold nanoparticle conjugates (MW=53376.38 g/mol, 100 mg, 1.87 μmol) were dissolved in 50 mM 2-(N-morpholino)ethanesulfonic acid (MES) buffer (pH 6.5; 30 mL) and the solution then made up to 0.1 M in 1-[3-(dimethylamino)-propyl]-3-ethylcarbodiimide hydrochloride (EDC) and 5.31 mM in N-hydroxysulfosuccinimide sodium salt. Toluidine Blue O (TBO, 61 mg, 0.2 mmol) was added, and the solution was stirred for 24 hours. Then, the reaction mixture was dialyzed as described above for 144 hours. The dark purple TBO-tiopronin-gold nanoparticle conjugate solution was collected from the dialysis tube, and the solvent was removed by freeze-drying. ¹H NMR spectroscopy (in D₂O/phosphate buffer-d; 8 mg of sample) revealed pure product. The number of molecules of TBO coupled to each nanoparticle was 15.4, as determined by ¹H NMR. This value was verified by elemental analysis. Anal. Found: C, 14.45; H, 1.91; Cl, 0.86; N, 3.35; S, 5.58. Calcd for C₆₅₆H_{895.6}Cl_{15.4}O_{239.6}N_{131.2}S_{100.4}Au₂₀₁: C, 13.63; H, 1.56; Cl, 0.94; N, 3.18; O, 6.63; S, 5.57; Au, 68.49.

### Examples 2-5

### Lethal Photosensitization of Staphylococcus aureus using a TBO-tiopronin-gold Nanoparticle Conjugate

### Example 2

### White light

An overnight culture of Staphylococcus aureus NCTC 6571 (1 ml; grown aerobically at 37° C., with shaking, in Nutrient Broth no. 2) was centrifuged and the pellet resuspended in phosphate buffered saline (“PBS”, 1 ml). The optical density at 600 nm was adjusted to 0.05 in PBS, in order to give an inoculum of approximately 10⁷-10⁸ cfu/ml.

The TBO-tiopronin-gold nanoparticle conjugate prepared prepared by a method analogous to that described in Example 1, approximate composition Au₂₀₁tiopronin₈₅TBO₁₁, was suspended in sterile distilled water at a concentration of 4.6 mg/ml. The conjugate solution was then diluted 1 in 2, 1 in 10 and 1 in 100 in sterile distilled water.

In a 96-well plate, 50 μl aliquots of the conjugate were added to 50 μl of the bacterial suspension, in triplicate, and irradiated with white light (28 W compact fluorescent lamp; 3600±20 lux) for 35 minutes. Controls consisted of:

(i) bacteria without conjugate, kept in the dark for an equal amount of time (“control”);

(ii) bacteria with conjugate, kept in the dark for an equal amount of time;

(iii) irradiated tiopronin-gold nanoparticle conjugate with free TBO;

(iv) irradiated tiopronin-gold nanoparticle conjugate alone.

After irradiation, samples were serially diluted 1 in 10 to a dilution factor of 10⁻⁴ and spread in duplicate onto 5% horse blood agar plates. The plates were then incubated aerobically at 37° C. for approximately 48 hours. After incubation, the surviving cfu/ml was calculated.

The results are summarized in Table 3. The conjugate had no effect when irradiated with white light for 35 minutes when used neat or at a dilution of 1 in 2, and little effect at a dilution of 1 in 100. However, antibacterial activity (approximately 4 log reduction in colony forming units/ml) was observed when the conjugate was diluted 1 in 10.

The absence of killing by the undiluted and 1 in 2 dilutions of the conjugate were likely to be due to light absorption by the very darkly colored solutions. The small kills detected using a 1 in 100 dilution were probably due to the very low concentrations of TBO present.

When not exposed to white light, no antibacterial activity was seen at any concentration of the conjugate tested. Furthermore, neither free TBO in combination with the tiopronin-gold nanoparticles, nor the tiopronin-gold nanoparticles alone achieved any killing of S. aureus 6571 at any of the concentrations tested.

### Example 3

### HeNe laser

The method of Example 2 was repeated using a helium-neon laser (power output=35 mW; emitting light at 632 nm) instead of white light, with an irradiation time of one minute. The results are shown in Table 3. As with the white light, the concentration that achieved the best killing of S. aureus was a 1 in 10 dilution. However in contrast to the results using the white light; antibacterial activity (approximately 2 log reduction in cfu/ml) was also observed when the conjugate was diluted 1 in 2.

### Example 4

### Effect of Light Dose (White Light)

The method of Example 2 was repeated, using TBO-Tiopronin-gold nanoparticle conjugate at 1 in 10 dilution. Samples were illuminated with the same white light source as described above for 15, 30, or 45 minutes.

Results are shown in Table 3. No antibacterial effect was observed after 15 minutes. The conjugate achieved approximately a two log reduction in the surviving cfu/ml after 30 minutes irradiation, increasing to an approximately 5 log reduction in cfu/ml after 45 minutes.

The effect of TBO alone was also investigated, and was found to have no effect when irradiated with white light for any length of time.

### Example 5

### Effect of Light Dose (HeNe Laser)

The method of Example 4 was repeated, but samples were irradiated with the HeNe laser described in Example 3 for 0.5, 1, 1.5, 2 or 5 min. Results are shown in Table 3. This was then repeated with irradiation for one, two or five minutes. Highly effective killing was achieved for exposure times of 1 min and above. As seen with white light, the results showed a dose response, in which killing of S. aureus increased with increased irradiation time, with most killing being seen at five minutes (approximately 5.5 log reduction in cfu/ml).

TABLE 3

| | Light | Irradiation | Dilution of | |
|---|---|---|---|---|
| Example | Source | time (min) | conjugate solution¹ | Result² |
| 2 | White | 35 | Neat | — |
| | | | 1 in 2 | — |
| | | | 1 in 10 | **** |
| | | | 1 in 100 | ** |
| 3 | HeNe laser | 1 | Neat | — |
| | | | 1 in 2 | **** |
| | | | 1 in 10 | **** |
| | | | 1 in 100 | * |
| 4 | White | 15 | 1 in 10 | — |
| | | 30 | | **** |
| | | 45 | | **** |
| 5 | HeNe laser | 0.5 | 1 in 10 | *** |
| | | 1 | | **** |
| | | 1.5 | | **** |
| | | 2 | | **** |
| | | 5 | | **** |

¹Before mixing with bacterial suspension
²Key: — less than 50% kill; * 50-90% kill; ** 90-95% kill; *** 95-99% kill; **** 99-100% kill

### Examples 6-7

### Lethal Photosensitization of Staphylococcus aureus using a Different TBO-tiopronin-gold Nanoparticle Conjugate

### Example 6

### White Light

An overnight culture of Staphylococcus aureus NCTC 6571 (1 ml; grown aerobically at 37° C., with shaking, in Nutrient Broth no. 2) was centrifuged and the pellet resuspended in phosphate buffered saline (“PBS”, 1 ml). The optical density at 600 nm was adjusted to 0.05 in PBS, in order to give an inoculum of approximately 10⁷-10⁸ cfu/ml.

A TBO-tiopronin-gold nanoparticle conjugate, prepared in Example 1, approximate composition Au₂₀₁tiopronin₈₅TBO_{15.4}, was suspended in PBS at a concentration of 4.6 mg/ml, such that the final TBO content was approximately 1 mM. The conjugate solution was then diluted in PBS to give final TBO concentrations of approximately 2 μM, 1.0 μM, 0.5 μM and 0.25 μM.

In a 96-well plate, 50 μl aliquots of the conjugate were added to 50 μl of the bacterial suspension, in triplicate, and irradiated with white light (28 W compact fluorescent lamp; 3600±20 lux) for 30 minutes. Controls consisted of:

(i) bacteria without conjugate;

(ii) TBO;

(iii) irradiated tiopronin-gold nanoparticle conjugate with free TBO at a final TBO concentration of 1 μM;

(iv) irradiated tiopronin-gold nanoparticle conjugate alone: it was calculated that prior to dilution, the TBO-tiopronin-gold nanoparticle conjugate contained approximately 81 μM tiopronin-gold, and therefore a stock solution of the tiopronin-gold nanoparticle conjugate was made up to this concentration and then diluted accordingly.

After irradiation, samples were serially diluted 1 in 10 to a dilution factor of 10⁻⁴ and spread in duplicate onto 5% horse blood agar plates. The plates were then incubated aerobically at 37° C. for approximately 48 hours. After incubation, the surviving cfu/ml was calculated.

The results are summarized in Table 4. There was a concentration-dependent reduction in the viable count of S. aureus on irradiation with white light for 30 mins. At a concentration of 2.0 μm, an approximately 5.5 log₁₀ reduction in the viable count was observed. Substantial kills were achieved using a conjugate concentration as low as 0.5 μm, whereas free TBO exhibited significant kills of the organism only at a concentration of 2.0 μm.

The TBO-free tiopronin-gold nanoparticles did not achieve any killing of S. aureus 6571 at any of the concentrations tested. Mixtures of various ratios of the tiopronin-gold conjugate and a sub-optimal concentration of TBO (1.0 μM) did not result in killing of the S. aureus on irradiation with white light.

### Example 7

### HeNe Laser

The method of Example 6 was repeated using a helium-neon laser (power output=35 mW; emitting light at 632 nm) instead of white light, with an irradiation time of one minute. The results are shown Table 4. As with the white light, the kills achieved were concentration-dependent—significant kills were achieved when the conjugate was used at a concentration as low as 0.5 μM.

TABLE 4

| | Light | Irradiation | TBO concentration | |
|---|---|---|---|---|
| Example | Source | time (min) | (μM) | Result¹ |
| 6 | White | 30 | 2.0 | **** |
| | | | 1.0 | **** |
| | | | 0.5 | **** |
| | | | 0.25 | * |
| 7 | HeNe laser | 1 | 2.0 | **** |
| | | | 1.0 | **** |
| | | | 0.5 | * |
| | | | 0.25 | — |

¹Key: — less than 50% kill; * 50-90% kill; ** 90-95% kill; *** 95-99% kill; **** 99-100% kill

1. A computer input device comprising a photosensitizer that provides an antimicrobial effect when activated by electromagnetic radiation.

2. A device according to claim 1, comprising a controller for determining whether said input device is being actively used.

3. A device according to claim 2, wherein said controller is arranged to initiate the supply of electromagnetic radiation to said input device after a certain time period of inactivity has elapsed.

4. A device according to claim 2, wherein said controller is arranged to initiate the supply of electromagnetic radiation to said device at times when the computer to which said input device is connected is turned off.

5. A device according to claim 2, wherein said controller is arranged to initiate the supply of electromagnetic radiation to said device at a time when said device is being actively used.

6. A device according to claim 2, further comprising means to deliver electromagnetic radiation to the photosensitizer.

7. A device according to claim 6, wherein said means to deliver electromagnetic radiation is arranged to continuously deliver electromagnetic radiation to said photosensitizer when said device is connected to a computer that is turned on.

8. A device according to claim 2, wherein said photosensitizer is embedded in a polymer used to make the device.

9. A device according to claim 6, wherein said device is a computer keyboard.

10. A computer keyboard according to claim 9, wherein said photosensitizer is provided on at least the keys of said keyboard.

11. A computer keyboard according to claim 9, wherein said means to deliver electromagnetic radiation delivers electromagnetic radiation to the keys of said keyboard.

12. A computer keyboard according to claim 11, wherein said means are internal to said keyboard.

13. A computer keyboard according to claim 12, wherein said means comprise at least one optical fibre and at least one source of electromagnetic radiation.

14. A computer keyboard according to claim 9, wherein said photosensitizer is embedded in a polymer used to make the keys of said keyboard.

15. A device according to claim 1, wherein said device is a computer mouse.

16. A device according to claim 2, wherein said electromagnetic radiation is light.

17. A device according to claim 2, wherein said electromagnetic radiation is visible light.

18. A device according to claim 2, wherein said photosensitizer is a light-activated antimicrobial polymer.

19. A device according to claim 18, wherein said polymer is provided as a coating to at least part of said device.

20. A device according to claim 2, wherein said device comprises nanoparticles.

21. A device according to claim 20, wherein said nanoparticles are gold or silver nanoparticles.

22. A device according to claim 2, wherein said device is made from transparent plastic.

23. A device according to claim 2, further comprising a LED light source arranged to deliver light to said photosensitizer.

24. A device according to claim 2, wherein said photosensitizer predominantly provides said antimicrobial effect by producing singlet oxygen.

25. A device according to claim 1, wherein said photosensitizer predominantly provides said antimicrobial effect by producing free radicals.

26. A device according to claim 2, wherein said photosensitizer is a metallic nanoparticle-ligand-photosensitizer conjugate.

27. A device according to claim 26, wherein
the ligand is a water-solubilizing ligand; and
the metallic nanoparticle and photosensitizer are chosen such that the conjugate generates singlet oxygen and/or free radicals.

28. A device according to claim 27, wherein the ligand comprises a thiol, xanthate, disulfide, dithiol, trithiol, thioether, polythioether, tetradentate thioether, dithiocarbamate, phosphine, phosphine oxide, alkanolamine, aminoacid, carboxylate, isocyanide, acetone, iodine, dialkyl-diselenide, thioaldehyde, thion acid, thion ester, thioamide, thioacyl halide, sulfoxide, sulfenic acid, sulfenyl halide, isothiocyanate, isothiourea, aliphatic or aromatic selenol, selenide, diselenide, selenoxide, selenenic acid, selenenyl, aliphatic or aromatic tellurol, telluride, or ditelluride.

29. A device according to claim 2, wherein said photosensitizer is included in a cover which covers the computer input device during use.

30. A cover for a computer input device comprising a photosensitizer that provides an antimicrobial effect when activated by electromagnetic radiation.

31. A cover according to claim 30, wherein said photosensitizer comprises nanoparticles.

32. A cover according to claim 31, wherein said nanoparticles are embedded in a polymer used to make the cover.

33. A cover according to claim 30, wherein said photosensitizer is a metallic nanoparticle-ligand-photosensitizer conjugate, preferably wherein
the ligand is a water-solubilizing ligand; and
the metallic nanoparticle and photosensitizer are chosen such that the conjugate generates singlet oxygen and/or free radicals.

34. A method of making an antimicrobial computer device, said method comprising:
providing a computer input device;
spraying a liquid photosensitizer onto said device; and
allowing said photosensitizer to dry.

35. A method of making an antimicrobial computer device, said method comprising:
embedding a photosensitizer into a polymer; and
manufacturing at least a part of said input device from said polymer.

36. A method according to claim 35, wherein said part is a key of a computer keyboard.

37. A method of providing an antimicrobial computer input device, said method comprising:
attaching an antimicrobial cover to said input device.

38. A method according to claim 37, wherein said antimicrobial cover comprises a photosensitizer that provides an antimicrobial effect when activated by electromagnetic radiation.

39. A method according to claim 34, wherein said photosensitizer comprises nanoparticles.

40. A method according to claim 37, wherein said antimicrobial cover comprises a metallic nanoparticle-ligand-photosensitizer conjugate, preferably wherein
the ligand is a water-solubilizing ligand; and
the metallic nanoparticle and photosensitizer are chosen such that the conjugate generates singlet oxygen and/or free radicals.

41. A laptop computer comprising a keyboard, in which the keys of the keyboard are provided with a photosensitizer that provides an antimicrobial effect when activated by electromagnetic radiation.

42. A laptop computer according to claim 41, further comprising a display screen that is arranged to emit electromagnetic radiation that activates said photosensitizer when said display screen is folded down over said keyboard.
